(19) United States
(12) Patent Application Publication
(10) Pub. No.: US 2022/0080827 A1
(43) Pub. Date: Mar. 17, 2022

(54) APPARATUS FOR DISPLAYING INFORMATION BASED ON AUGMENTED REALITY

(71) Applicants: Hyundai Motor Company, Seoul (KR); Kia Corporation, Seoul (KR); HYUNDAI AUTOEVER Corp, Seoul (KR)

(72) Inventors: Tae Hyun SUNG, Seoul (KR); Bum Hee CHUNG, Seoul (KR); Ji Won SA, Seoul (KR); Hye Young JEONG, Seoul (KR)

(73) Assignees: Hyundai Motor Company, Seoul (KR); Kia Corporation, Seoul (KR); HYUNDAI AUTOEVER Corp, Seoul (KR)

(21) Appl. No.: 17/410,156

(22) Filed: Aug. 24, 2021

(30) Foreign Application Priority Data
Sep. 15, 2020 (KR) 10-2020-0118480

(51) Int. Cl. B60K 35/00; B60W 30/095; B60K 37/04; B60W 30/10; B60W 30/16

(52) U.S. Cl. CPC B60K 35/00; B60W 30/095; B60K 37/04; B60W 30/10; B60K 2370/166; B60K 2370/1529; B60K 2370/177; B60K 2370/178; B60K 2370/179; B60W 30/16

(57) ABSTRACT

An information display apparatus may include a processor configured to display collision warning information or inter-vehicle distance information in augmented reality; and a storage configured to store data and algorithms driven by the processor, wherein the processor is configured to control highlight display of a target vehicle depending on presence or absence of position information related to the target vehicle according to information received from a vehicle control device, and the information display apparatus is disposed within a vehicle or outside the vehicle, and when disposed outside the vehicle, transmits the collision warning information or the inter-vehicle distance information to the vehicle or a mobile device.

### CROSS-REFERENCE TO RELATED APPLICATION

The present application claims priority to Korean Patent Application No. 10-2020-0118480, filed on Sep. 15, 2020, the entire contents of which is incorporated herein for all purposes by this reference.

### BACKGROUND OF THE INVENTION

### Field of the Invention

The present invention relates to an information display apparatus based on augmented reality, and more particularly, to a display technique based on augmented reality for maximizing customer experience in a means of transportation.

### Description of Related Art

In general, vehicles (means of transportation) have become essential products in a modern society as their mobility and usability are improved by applying advanced technique, and recently, a head-up display (HUD) has been used to project information onto driver's eyes.

The head-up display is a front display device designed to display driving information related to a vehicle on front glass of the vehicle. That is, a head-up display unit is displayed by forming a virtual image such that a driver can recognize various types of information, such as a speed, a fuel level, a temperature, and a warning direction displayed on a vehicle cluster, on windshield glass.

Furthermore, a navigation system is mounted on a recent means of transportation to provide a destination and directions to a driver, and furthermore, in the navigation system to which augmented reality is applied, specific information may be displayed in a form of augmented reality. However, accuracy and diversity of information provided by use of augmented reality in the navigation system is poor.

In particular, in the case of a forward collision warning (FCW) system in an autonomous driving vehicle, it is difficult to trust whether the FCW system is accurately recognizing a dangerous situation because a position of a target vehicle is not displayed when FCW is performed.

Furthermore, in the case of existing smart cruise control, an actual position of the target vehicle or a distance value thereof is not displayed but it is performed by use of a host vehicle icon displayed on a cluster and display indication of a target vehicle icon, and thus it is difficult to confirm that a position of the vehicle in front is accurately recognized. It is also difficult to understand how much margin is actually set for a predetermined SCC value, and since simple information is not displayed in augmented reality, icons for each step value are often not understood.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a driving information display apparatus based on augmented reality, configured for minimizing a sense of heterogeneity and maximizing an emphasis effect on objects by displaying collision warning information related to a means of transportation, inter-vehicle distance control information, departure information related to a target vehicle, or the like based on augmented reality.

The technical objects of the present invention are not limited to the objects mentioned above, and other technical objects not mentioned may be clearly understood by those skilled in the art from the description of the claims.

Various aspects of the present invention are directed to providing an information display apparatus, including: a processor configured to display collision warning information or inter-vehicle distance information in augmented reality; and a storage configured to store data and algorithms driven by the processor, wherein the processor is configured to control highlight display of a target vehicle depending on presence or absence of position information related to the target vehicle according to information received from a vehicle control device, and the information display apparatus is disposed within a vehicle or outside the vehicle, and when disposed outside the vehicle, transmits the collision warning information or the inter-vehicle distance information to the vehicle or a mobile device.

In various exemplary embodiments of the present invention, the processor may distinguish and display highlights for the target vehicle when the position information related to the target vehicle exists and when the position information related to the target vehicle does not exist.

In various exemplary embodiments of the present invention, the processor may distinguish the highlight display in highlights by differently displaying at least one of sizes, colors, and shapes thereof.

In various exemplary embodiments of the present invention, the received information may include at least one of a horizontal position value and a vertical position value of the target vehicle, and the processor may determine a display position of the target vehicle according to at least one of the horizontal position value and the vertical position value.

In various exemplary embodiments of the present invention, the processor, when the horizontal position value is not received or reliability of the horizontal position value which is received is lower than a predetermined value, may estimate the display position of the target vehicle by use of a traveling direction of the target vehicle.

In various exemplary embodiments of the present invention, the processor may adjust a size of a highlight displayed on the target vehicle to correspond to an error range of the display position of the target vehicle.

In various exemplary embodiments of the present invention, the processor, when the vertical position value is not received or reliability of the vertical position value that is received is low, may determine the vertical position value by use of a relative speed of the target vehicle with respect to the vehicle and a time remaining until collision of the vehicle with the target vehicle.

In various exemplary embodiments of the present invention, the processor may determine and display the display position of the target vehicle by limiting the vertical position value to a predetermined value when the vertical position value is greater or smaller than or equal to a predetermined reference value.

In various exemplary embodiments of the present invention, the processor may filter cases in which the determined vertical position value is less than a predetermined first reference value and exceeds a predetermined second reference value which is greater than the first reference value.

In various exemplary embodiments of the present invention, the processor may obtain the collision warning information or the inter-vehicle distance control information in connection with an in-vehicle forward collision warning (FCW) system or a smart cruise control (SCC) system.

In various exemplary embodiments of the present invention, the processor may display the inter-vehicle distance information depending on an inter-vehicle distance setting step in the augmented reality when setting an inter-vehicle distance.

In various exemplary embodiments of the present invention, the processor may display an inter-vehicle distance setting value or an inter-vehicle distance setting range that varies depending on a vehicle speed or a road grade.

In various exemplary embodiments of the present invention, the collision warning information may include an indicator and a marker, and the processor may track the target vehicle, may display the marker around the target vehicle, and may display the indicator at a fixed position on a screen displaying the collision warning information.

Various aspects of the present invention are directed to providing an information display apparatus, including: a processor configured to display departure information related to a target vehicle in augmented reality; and a storage configured to store data and algorithms driven by the processor, wherein the processor, based on information received from a vehicle control device, is configured to display the departure information related to the target vehicle based on at least one of a traveling direction thereof, a path, and a lane trajectory of the target vehicle, and the information display apparatus is disposed within a vehicle or outside the vehicle, and when disposed outside the vehicle, transmits the departure information related to the target vehicle to the vehicle or a mobile device.

In various exemplary embodiments of the present invention, the processor may display a predetermined display object indicating the traveling direction of the target vehicle in a carpet to move it from the host vehicle to the target vehicle when displaying the departure information related to the target vehicle.

In various exemplary embodiments of the present invention, the predetermined display object may include a fishbone shape or a straight line (-) shape.

In various exemplary embodiments of the present invention, the processor may fix the display object, which is moved when the host vehicle departs after the target vehicle departs, in the carpet to continuously display the predetermined display object.

In various exemplary embodiments of the present invention, the processor may determine position information related to the target vehicle and a distance between the target vehicle and the host vehicle, and may estimate a curve of a traveling direction of the target vehicle within a range of a maximum distance that the target vehicle is able to move.

According to the present technique, it is possible to minimize a sense of heterogeneity and maximizing an emphasis effect on objects by displaying collision warning information related to a means of transportation, inter-vehicle distance control information, departure information related to a target vehicle, or the like based on augmented reality.

Furthermore, various effects which may be directly or indirectly identified through the present document may be provided.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1A illustrates a block diagram showing a configuration of an information display apparatus according to various exemplary embodiments of the present invention.

FIG. 1B illustrates a block diagram showing a configuration of an information display apparatus according to various exemplary embodiments of the present invention.

FIG. 2 illustrates an example of a screen displaying information based on augmented reality depending on a horizontal position value and a vertical position value according to various exemplary embodiments of the present invention.

FIG. 3A illustrates a view for describing an example of displaying a target vehicle when there is a horizontal position value according to various exemplary embodiments of the present invention.

FIG. 3B illustrates a view for describing an example of displaying a target vehicle when there is no horizontal position according to various exemplary embodiments of the present invention.

FIG. 4 illustrates an example of a screen displaying collision warning information based on augmented reality according to various exemplary embodiments of the present invention.

FIG. 5 illustrates an example of a screen to which an animation is applied for displaying an inter-vehicle distance based on augmented reality according to various exemplary embodiments of the present invention.

FIG. 6A and FIG. 6B illustrate an example of a screen displaying departure information related to a target vehicle in augmented reality according to various exemplary embodiments of the present invention.

FIG. 7A, FIG. 7B, and FIG. 7C illustrate an example of a screen displaying departure information related to a target vehicle in augmented reality according to various exemplary embodiments of the present invention.

It may be understood that the appended drawings are not necessarily to scale, presenting a somewhat simplified representation of various features illustrative of the basic principles of the present invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, some exemplary embodiments of the present invention will be described in detail with reference to exemplary drawings. It may be noted that in adding reference numerals to constituent elements of each drawing, the same constituent elements have the same reference numerals as possible even though they are indicated on different drawings. Furthermore, in describing exemplary embodiments of the present invention, when it is determined that detailed descriptions of related well-known configurations or functions interfere with understanding of the exemplary embodiments of the present invention, the detailed descriptions thereof will be omitted.

In describing constituent elements according to various exemplary embodiments of the present invention, terms such as first, second, A, B, (a), and (b) may be used. These terms are only for distinguishing the constituent elements from other constituent elements, and the nature, sequences, or orders of the constituent elements are not limited by the terms. Furthermore, all terms used herein including technical scientific terms have the same meanings as those which are generally understood by those skilled in the Field of the Invention to which various exemplary embodiments of the present invention pertains (those skilled in the art) unless they are differently defined. Terms defined in a generally used dictionary shall be construed to have meanings matching those in the context of a related art, and shall not be construed to have idealized or excessively formal meanings unless they are clearly defined in the present specification.

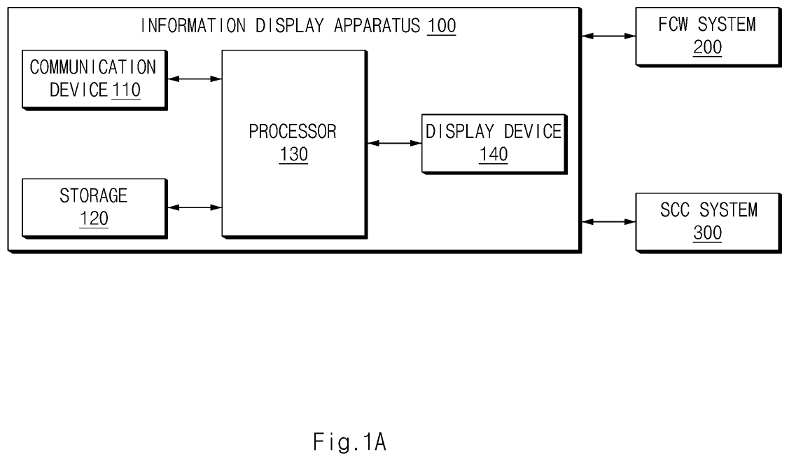

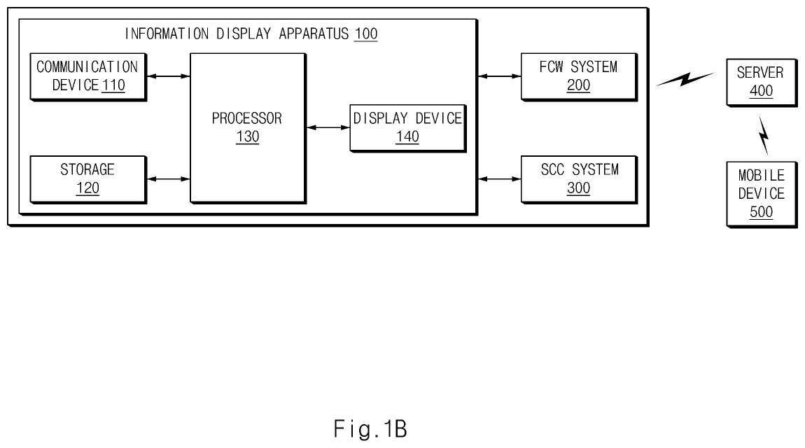

Hereinafter, various exemplary embodiments of the present invention will be described in detail with reference to FIG. 1A to FIG. 7C.

FIG. 1A illustrates a block diagram showing a configuration of an information display apparatus according to various exemplary embodiments of the present invention. FIG. 1B illustrates a block diagram showing a configuration of an information display apparatus according to various exemplary embodiments of the present invention.

The information display apparatus of the present invention may be applied to all means of transportation, and the means of transportation may include a four-wheeled means of transportation, such as a vehicle or a truck, a two-wheeled means such as a motorcycle or a bicycle, and all movable means such as an aircraft or a ship, the information display apparatus may display information such as a destination, a stopover area, a point of interest (POI), and a driving state of a means of transportation, and may be implemented as a navigation system, an audio video navigation (AVN), or the like.

Referring to FIG. 1A, according to various exemplary embodiments of the present invention, the display information apparatus 100 may be implemented inside the means of transportation. In the instant case, the information display apparatus 100 may be integrally formed with internal control units of the means of transportation, and may be implemented as a separate device to be connected to the control units of the means of transportation by a separate connecting means. Furthermore, the information display apparatus 100 may be configured in a form of a server 400 outside the means of transportation as illustrated in FIG. 1B, and outside the means of transportation, the server 400 transmits driving information to a vehicle device or a mobile device 500 to display it based on augmented reality. That is, the server 400 may receive vehicle control information (collision warning information or inter-vehicle distance control information, etc.) in connection with an in-vehicle forward collision warning (FCW) system 200, a smart cruise control (SCC) system 300, and the like, to transmit vehicle information corresponding thereto to the in-vehicle information display apparatus 100. In the instant case, the mobile device 500 may include all mobile communication terminals having a display device, such as a smart phone, a personal digital assistant (PDA), a portable multimedia player (PMP), a digital camera, a portable game machine, an MP3 player, a smart key, a tablet PC, as a user terminal. When driving information is transmitted from an outside of the vehicle to the vehicle, it may be transmitted from a device or a server outside the vehicle to an in-vehicle device, and the in-vehicle device may include, e.g., a cluster, a head-up display, a navigation terminal, an audio, a video, a navigation (AVN), and the like.

Furthermore, the information display apparatus 100 in various exemplary embodiments of the present invention may be applied to autonomous driving control vehicles, such as advanced driver assistance systems (ADAS), smart cruise control (SCC) systems, and forward collision warning (FCW) systems, and may display information which is received through transmission/reception with respect to the ADAS, the SCC systems, the FCW systems, or the like, based on augmented reality.

That is, the information display apparatus 100 may display collision warning information and inter-vehicle distance control information based on augmented reality in connection with an FCC system 200, a SCC system 300, and the like. Furthermore, the information display apparatus 100 may display departure information related to the target vehicle based on augmented reality.

According to the exemplary embodiment of the present invention, the information display apparatus 100 which is operated as the above may be implemented in a form of an independent hardware device including a memory and a processor that processes each operation, and may be driven in a form included in other hardware devices such as a microprocessor or a general purpose computer system.

Referring to FIG. 1A and FIG. 1B, the information display apparatus 100 of the means of transportation may include a communication device 110, a storage 120, and a processor 130, and a display device 140.

The communication device 110, which is a hardware device implemented with various electronic circuits to transmit and receive signals through a wireless or wired connection, may perform V2I communication by use of an in-vehicle network communication technique or a wireless Internet access or short range communication technique with servers, infrastructure, and other vehicles outside the vehicle in various exemplary embodiments of the present invention. Herein, in-vehicle communication may be performed through controller area network (CAN) communication, local interconnect network (LIN) communication, or flex-ray communication as the in-vehicle network communication technique. Furthermore, the wireless communication technique may include wireless LAN (WLAN), wireless broadband (Wibro), Wi-Fi, Worldwide Interoperability for Microwave Access (WiMAX), etc. Furthermore, short-range communication technique may include Bluetooth, ZigBee, ultra wideband (UWB), radio frequency identification (RFID), infrared data association (IrDA), and the like.

As an example, the communication device 110 may receive traffic information, road information, vehicle information for display based on augmented reality, and the like from an external server 400. As an example, vehicle information to be displayed based on augmented reality may include collision warning information, inter-vehicle distance information with a vehicle in front, departure information related to the vehicle in front, position information related to a target vehicle, path information, road information, position information related to a host vehicle, and the like.

The storage 120 may store information received by the communication device 110, data obtained by the processor 130, data and/or algorithms required for the processor 130 to operate, and the like. As an example, the storage 120 may include position information related to a means of transportation and information related to the means of transportation for display based on augmented reality. The information related to the means of transportation may include a position of a target vehicle, collision warning information with the target vehicle, inter-vehicle distance information with the target vehicle (front vehicle), and the like.

The storage 120 may include a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and an optical disk.

The processor 130 may be electrically connected to the communication device 110, the storage 120, and the like, may electrically control each component, and may be an electrical circuit that executes software commands, performing various data processing and calculations described below. The processor 130 may be, e.g., an electronic control unit (ECU), a micro controller unit (MCU), or other subcontrollers mounted in the vehicle.

The processor 130 may display vehicle information in connection with the FCW system 200 or the SCC system 300.

The FCW system 200 determines a possibility of collision with the target vehicle, and when there is the possibility of collision, performs collision warning to the user. The processor 130 may receive information for displaying the collision warning from the FCW system 200, and display the collision warning based on augmented reality through the display device 140.

In the instant case, when the position information related to the target vehicle (horizontal position value, vertical position value, etc.) is not included in the information received from the FCW system 200 or even when the position information related to the target vehicle is included therein, there may be cases where reliability of the information is low due to errors, etc.

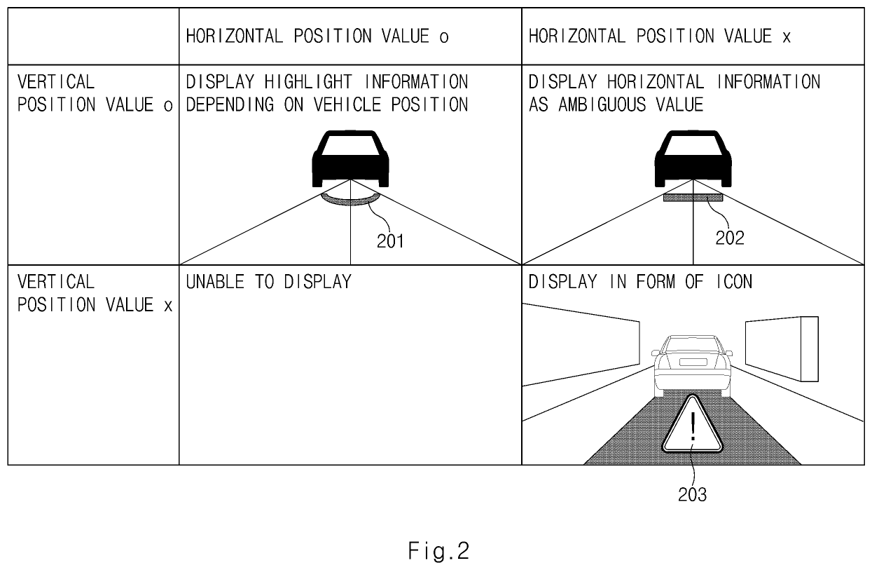

Accordingly, the processor 130 may differently apply whether or not the target vehicle (e.g., vehicle in front) is highlighted and a color, a shape, and a size of the highlight depending on the presence or absence of the vertical position value and the horizontal position value of the target vehicle with which it is expected to collide. FIG. 2 illustrates an example of a screen displaying information based on augmented reality depending on a horizontal position value and a vertical position value according to various exemplary embodiments of the present invention.

Referring to FIG. 2, when both the vertical position value and the horizontal position value of the target vehicle exist (assuming that the information has no error), the processor 130 may display a highlight 201 corresponding to the vertical position value and the horizontal position value of the target vehicle.

Meanwhile, when the vertical position value of the target vehicle exists but the horizontal position value does not exist, the processor 130 may estimate the position of the target vehicle by use of a traveling direction of the target vehicle, and may display the position of the target vehicle. However, since an error of the estimated value may be generated, the processor 130 may adjust a size of a highlight 202 indicating the position of the target vehicle in consideration of such an error range. For example, the size of the highlight 202 may be displayed longer in consideration of the error range.

In FIG. 2, when both the vertical position value and the horizontal position value of the target vehicle exist (error-free information), the position information related to the target vehicle is accurate, and thus the curved highlight 201 is displayed under the target vehicle.

On the other hand, when the horizontal position value does not exist or is unreliable, a lateral position of the target vehicle is incorrect, and thus a user can intuitively recognize cases that the position information related to the target vehicle is correct or incorrect by displaying a straight highlight 202 at a lower portion of the target vehicle.

Accordingly, in the past, a warning indication of a collision with the target vehicle was provided, but there was no UI application to display the position of the target vehicle, and even when the position of the target vehicle is displayed, its accuracy is low or it is not possible to distinguish cases where information related to the position of the target vehicle is not received, and thus there are many cases where a range of application for displaying the collision warning is narrow. However, in various exemplary embodiments of the present invention, even when the information related to the position of the target vehicle cannot be received or its reliability is low, a display method may be provided to increase the application range. That is, when the horizontal position value of the target vehicle is not sufficiently provided, the processor 130 may minimize a damage of information reliability by changing the display method.

In an exemplary embodiment of the present invention, whether the reliability on the information related to the position of the target vehicle is low, is determined quantitively in experiment such that the reliability is low if the quantified reliability is lower than a predetermined value.

Furthermore, when the vertical position value of the target vehicle does not exist and the horizontal position value exists, the processor 130 may determine that the display is impossible, while when neither the vertical position value nor the horizontal position value exists, the processor 130 may display collision warning in a form of an icon 203 as illustrated in FIG. 2.

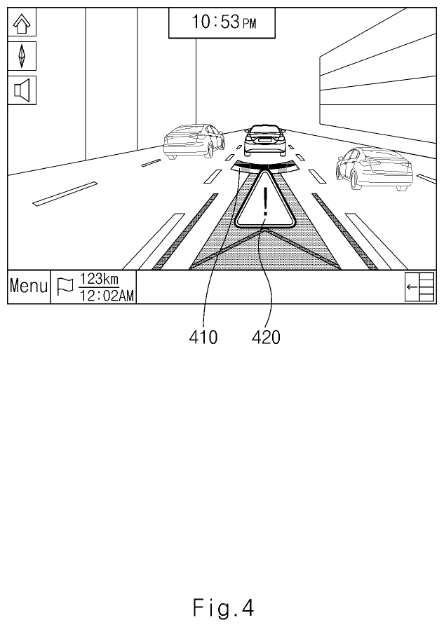

That is, when the vertical position value is not received or even when the vertical position value is received but reliability of the received vertical position value is low, the processor 130 may display collision warning information with the target vehicle based on augmented reality in a following manner. In the instant case, the collision warning information may include an indicator 410 and a marker 420 as illustrated in FIG. 4. FIG. 4 illustrates an example of a screen displaying collision warning information based on augmented reality according to various exemplary embodiments of the present invention.

As illustrated in FIG. 4, the processor 130 may track the target vehicle and displays a marker around the target vehicle, and may display an indicator at a fixed position on a screen displaying the collision warning information. FIG. 4 illustrates an example in which the indicator is fixed in a space between a vehicle in front and the host vehicle, but the present invention is not limited thereto, and it may be fixed and displayed in a predetermined area on the screen.

First, the processor 130 may determine the vertical position value of the target vehicle by performing inverse calculation based on a relative speed of the target vehicle and a remaining time until the collision with the target vehicle, to display the target vehicle in a corresponding position thereof.

Furthermore, the processor 130 may limitedly display a value for a display distance which is equal to or greater than or equal to a predetermined reference to prepare for a case where an error is included in relative information such as a relative speed of the target vehicle and a remaining time until the collision with the target vehicle. For example, a distance of 5 m or less from the host vehicle may be displayed as a batch of 5 m.

Furthermore, the processor 130 may improve a sense of heterogeneity in the display by applying a filter for the determined display distance to prevent an error range from being expanded due to an increase in a factor. In the instant case, the processor 130 may prevent the error range from being expanded and minimize the sense of heterogeneity in the display by filtering and using information received from the FCW system 200 and the SCC system 300 or information obtained from the host vehicle to estimate position information related to the target vehicle. That is, the processor 130 may minimize the error range by filtering cases in which the determined vertical position value is smaller than a predetermined first reference value and exceeds a predetermined second reference value which is greater than the first reference value.

Accordingly, the processor 130 in various exemplary embodiments of the present invention may accurately determines the position of the target vehicle by use of the relative speed of the target vehicle and the remaining time (distance) until the collision with the target vehicle, and may improve the inaccuracy by selecting a minimum or maximum display range in preparation for the inaccuracy of the relevant information.

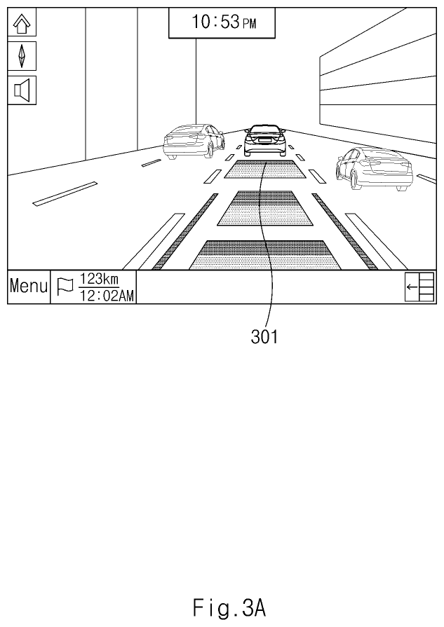

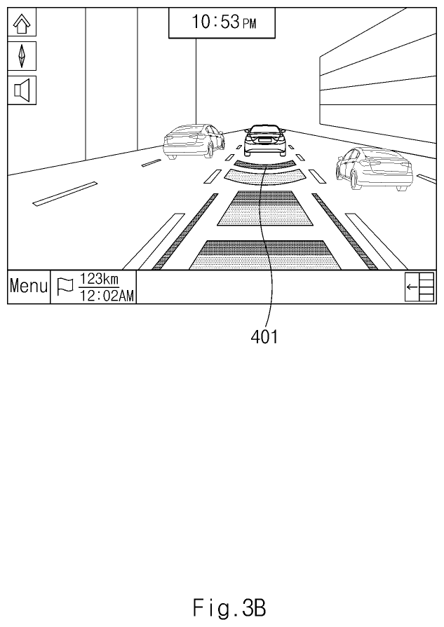

The SCC system 300 may set an inter-vehicle distance and control the inter-vehicle distance with the vehicle in front depending on the set value. The processor 130 may receive inter-vehicle distance setting information from the SCC system 300, and may display the inter-vehicle distance to the target vehicle based on augmented reality through the display device 140 as illustrated in FIG. 3A and FIG. 3B.

The processor 130 may perform highlight display on the target vehicle by receiving the position information related to the target vehicle from the SCC system 300 or estimating a position of the target vehicle based on information received from the SCC system 300. Accordingly, the processor 130 may accurately inform the user of a current vehicle state through such a position display.

Like the technique that performs display in connection with the FCW system 200, the processor 130 may differentiate and display the color, size, shape, and the like of the highlight depending on the presence or absence of the vertical position value and the horizontal position value of the target vehicle or the reliability of the received information. The processor 130 may estimate that there is no horizontal position value information when left and right values of the horizontal position value are received as (0,0) for a predetermined time period or longer.

FIG. 3A illustrates a view for describing an example of displaying a target vehicle when there is a horizontal position value according to various exemplary embodiments of the present invention, and FIG. 3B illustrates a view for describing an example of displaying a target vehicle when there is no horizontal position according to various exemplary embodiments of the present invention.

In FIG. 3A, a highlight 301 of the target vehicle when the horizontal position value does not exist and a highlight 401 of the target vehicle when the horizontal position value exists are separately displayed.

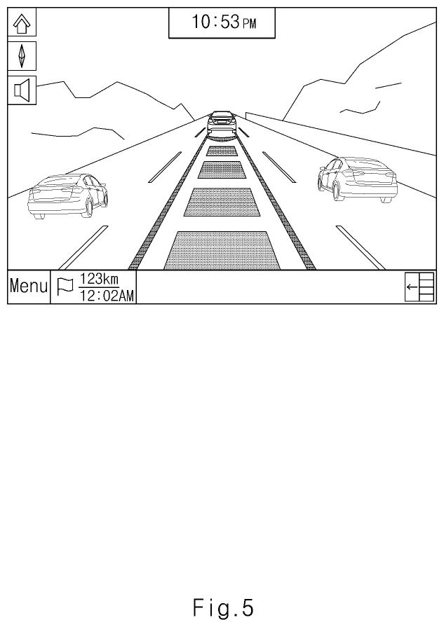

When the horizontal position value of the target vehicle received from the SCC system 300 changes from X to 0, the processor 130 may connect and display them as an animation as illustrated in FIG. 5. FIG. 5 illustrates an example of a screen to which an animation based on augmented reality is applied according to various exemplary embodiments of the present invention.

The processor 130 may display departure information related to the target vehicle (vehicle in front) based on augmented reality. Previously, the display of the departure information related to the target vehicle was limited to a simple information display that was not linked with the existing information.

Accordingly, the processor 130 in various exemplary embodiments of the present invention may estimate and display an expected traveling direction by use of at least one of a traveling direction of the target vehicle, a vehicle path, and a lane trajectory. The processor 130 may notify that a target vehicle 11 has departed by moving a display object for notification of the departure information related to the target vehicle.

In the instant case, the display object may include a fish-bone shape or a straight line (-) shape indicating a traveling direction in a carpet, and the processor 130 may control such a display object to move from a lane in front of the host vehicle to the position of the target vehicle, and to be fixed in the carpet when the host vehicle starts to move, to be continuously displayed from the host vehicle to the position of the target vehicle.

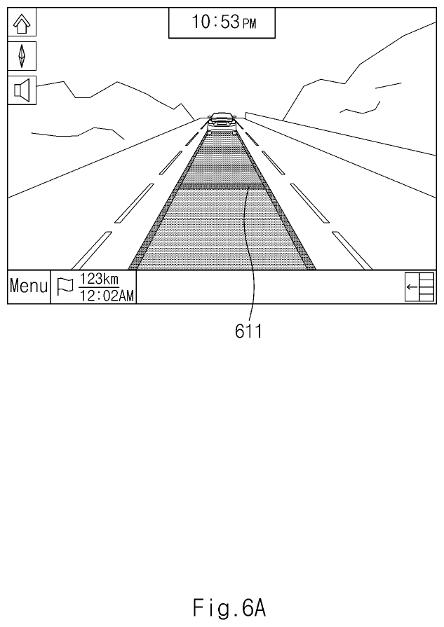

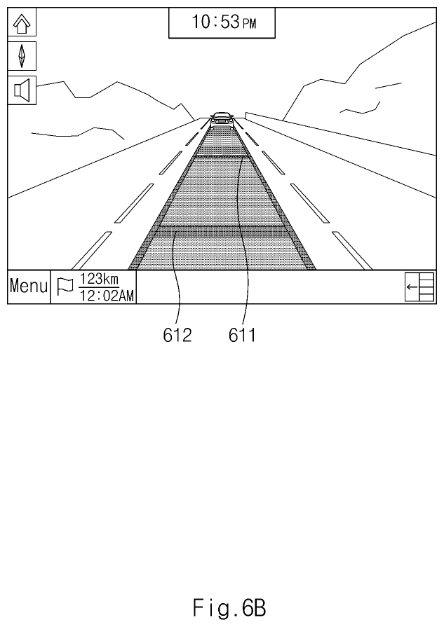

FIG. 6A and FIG. 6B illustrate an example of a screen displaying departure information related to a target vehicle in augmented reality according to various exemplary embodiments of the present invention.

In the case where the host vehicle is stopped and the target vehicle 11 departs as illustrated in FIG. 6A in a state where the host vehicle and the target vehicle 11 are stopped, a straight line (-) shape 611 is displayed in a carpet, and the straight line (-) shape 611 moves to notify that the target vehicle 11 has started. As the target vehicle 11 moves away as illustrated in FIG. 6B, a straight line (-) shape 612 in the carpet is displayed on a carpet in front of the host vehicle and moves to a lower end portion of the target vehicle 11.

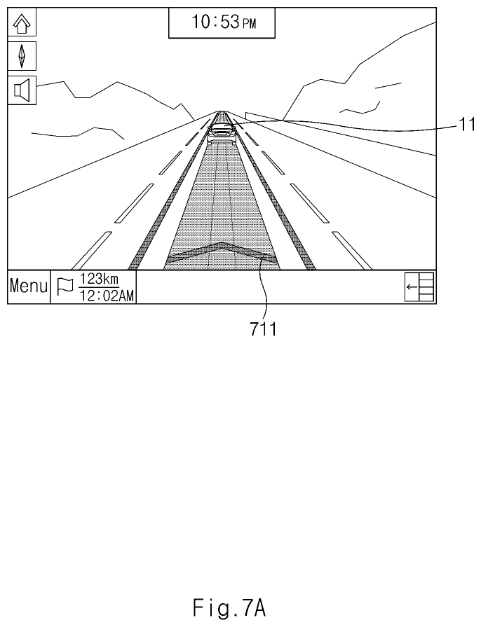

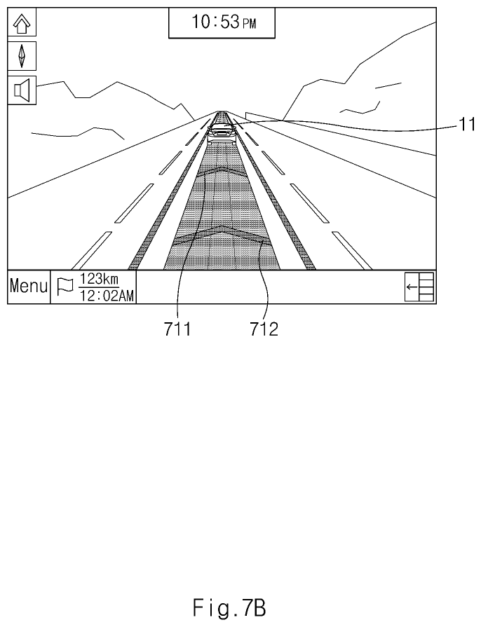

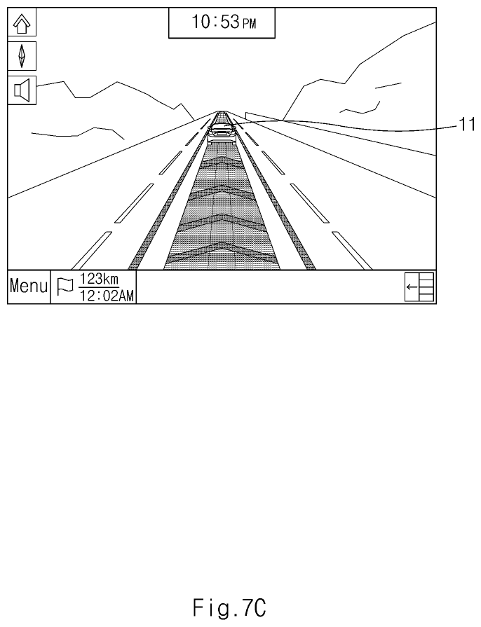

FIG. 7A, FIG. 7B, and FIG. 7C illustrate an example of a screen displaying departure information related to a target vehicle in augmented reality according to various exemplary embodiments of the present invention. FIG. 7A and FIG. 7B illustrate an example in which a fishbone ( [symbol] ) form 711 is displayed in the carpet when the target vehicle 11 starts, and the fishbone shape 711 moves to notify that the target vehicle 11 has started. That is, as the target vehicle 11 moves away, the fishbone shape 712 in the carpet is displayed on a carpet in front of the host vehicle and moves to the lower end portion of the target vehicle 11. Thereafter, when the host vehicle starts to depart, the fishbone shape that has been moving is displayed by being fixed to the carpet between the vehicle 11 in front the host vehicle, and may be displayed as illustrated in FIG. 7C. In the instant case, a fishbone shape or a straight line (-) shape that was displayed and moved to notify the departure of the target vehicle is not stopped and is continuously fixed to the carpet to be displayed, increasing user's visibility.

That is, FIG. 7C illustrates an example of displaying a carpet to have a shape of a fishbone when both the host vehicle and the target vehicle are driving, and in the instant case, the fishbone shape may be fixed and displayed on the carpet, and the fishbone shape may provide a user with a feeling of approaching the host vehicle as the host vehicle drives.

Furthermore, the processor 130 may naturally display a moving direction thereof, in which movement of the target vehicle is expected, in a form of a fishbone by determining a curvature degree of the carpet (road) depending on a steering movement and linking the position information related to the target vehicle.

That is, the processor 130 may estimate a curve within a maximum distance range that the target vehicle can move by determining position information related to the target vehicle and a distance to the host vehicle, to implement a fishbone form by use of information related to the estimated curve.

The processor 130 may display a step-by-step distance for setting the inter-vehicle distance based on augmented reality as illustrated in FIG. 5. For example, in the case of step 4 of the SCC system, a predetermined inter-vehicle distance may be displayed in step 4 of the SCC system. However, even in step 4 of the SCC system, the inter-vehicle distance may vary depending on a vehicle speed or a road grade.

In the past, it was difficult for a user to understand how much margin is set for a SCC setting value, and it was difficult to understand icons for each step value because simple information was not displayed in augmented reality. That is, when setting the inter-vehicle distance of the SCC system 300, it may be difficult to recognize information related to a currently set value on a general map. That is, setting of the SCC inter-vehicle distance determines steps depending on user's preference. However, even at a same step, the distance may vary depending on a vehicle speed or a surrounding environment, so it may be difficult for a user to recognize a level which is appropriate for the user when adjusting the step.

Accordingly, when the inter-vehicle distance changes depending on the vehicle speed or the road grade, the processor 130 in various exemplary embodiments of the present invention may update the changed inter-vehicle distance information to display the inter-vehicle distance information differently. For example, in step 4 of the SCC system, when the vehicle speed is low, the inter-vehicle distance is set to be smaller than a predetermined distance (e.g., 10 m), and when the vehicle speed is high in same step 4 of the SCC system, the inter-vehicle distance may be set to be greater than a predetermined distance (e.g., 40 m). Accordingly, a change in the inter-vehicle distance depending on the change in vehicle speed information may be applied to an augmented reality display.

Furthermore, when a same inter-vehicle distance setting value is set as ranges depending on the vehicle speed or the road grade, the processor 130 may include all of the ranges to display them. For example, in the case of a second-step inter-vehicle distance setting value, a range of 10 m to 60 m may be displayed, and in the case of a fourth-step inter-vehicle distance setting value, a range of 20 m-120 m may be displayed.

The display device 140 is controlled by the processor 130 to display vehicle information based on augmented reality. For example, the display device 140 may display collision warning information with the target vehicle (relative speed of the target vehicle, time remaining until collision, collision point, position of the target vehicle, etc.), inter-vehicle distance information with the target vehicle, departure information related to the target vehicle.

As an example, the display device 140 may be implemented as a head-up display (HUD), a cluster, an audio video navigation (AVN), or a human machine interface (HMI). Furthermore, the display device 140 may include at least one of a liquid crystal display (LCD), a thin film transistor liquid crystal display (TFT LCD or thin film transistor-LCD), a light emitting diode (LED) display, an organic light emitting diode (OLED or organic LED) display, an active OLED (AMOLED or active matrix OLED) display, a flexible display, a bended display, and a 3D display. Some of these displays may be implemented as a transparent display formed of a transparent or translucent type such that the outside may be viewed. Furthermore, the display device 140 may be provided as a touch screen including a touch panel, and may be used as an input device as well as an output device.

Accordingly, according to various exemplary embodiments of the present invention, it is possible to improve the user's recognition and minimize the sense of heterogeneity by displaying information related to the means of transportation based on augmented reality.

According to various exemplary embodiments of the present invention, it is possible to allow the user to intuitively determine whether the position information related to the target vehicle is accurate by displaying vehicle collision warning, vehicle distance information, etc. based on augmented reality in connection with autonomous driving control devices such as FCW and SCC systems in the vehicle and by displaying the size, shape, and color of the highlight that displays the target vehicle differently depending on the presence or absence of the position information related to the target vehicle.

According to various exemplary embodiments of the present invention, it is also possible to naturally display a change in the state of the vehicle by displaying departure information related to the target vehicle based on augmented reality and displaying the carpet to have the fishbone shape.

Furthermore, according to various exemplary embodiments of the present invention, it is possible to provide a user with accurate information on a target of the current vehicle by displaying an inter-vehicle distance setting indication and the position of the target vehicle based on an actual distance.

The above description is merely illustrative of the technical idea of the present invention, and those skilled in the art to which various exemplary embodiments of the present invention pertains may make various modifications and variations without departing from the essential characteristics of the present invention.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. An information display device comprising:
a processor configured to display collision warning information or inter-vehicle distance information in augmented reality; and
a storage configured to store data and algorithms driven by the processor,
wherein the processor is configured to control highlight display of a target vehicle depending on presence or absence of position information related to the target vehicle according to information received from a vehicle control device, and
wherein the information display apparatus is disposed within a vehicle or outside the vehicle, and when disposed outside the vehicle, is configured to transmit the collision warning information or the inter-vehicle distance information to the vehicle or a mobile device.

2. The information display device of claim 1, wherein the processor is configured to distinguish and display highlights for the target vehicle when the position information related to the target vehicle exists and when the position information related to the target vehicle does not exist.

3. The information display device of claim 1, wherein the processor is configured to distinguish the highlight display in highlights by differently displaying at least one of sizes, colors, and shapes thereof.

4. The information display device of claim 1, wherein the information received from the vehicle control device includes at least one of a horizontal position value and a vertical position value of the target vehicle.

5. The information display device of claim 4, wherein the processor is configured to determine a display position of the target vehicle according to at least one of the horizontal position value and the vertical position value.

6. The information display device of claim 5, wherein the processor, when the horizontal position value is not received or reliability of the horizontal position value which is received is lower than a predetermined value, is configured to estimate the display position of the target vehicle by use of a traveling direction of the target vehicle.

7. The information display device of claim 6, wherein the processor is configured to adjust a size of a highlight displayed on the target vehicle to correspond to an error range of the display position of the target vehicle.

8. The information display device of claim 5, wherein the processor, when the vertical position value is not received or reliability of the vertical position value that is received is lower than a predetermined value, is configured to determine the vertical position value by use of a relative speed of the target vehicle with respect to the vehicle and a time remaining until collision of the vehicle with the target vehicle.

9. The information display device of claim 8, wherein the processor is configured to determine and display the display position of the target vehicle by limiting the vertical position value to a predetermined value when the vertical position value is greater or smaller than or equal to a predetermined reference value.

10. The information display device of claim 8, wherein the processor is configured to filter cases in which the determined vertical position value is smaller than a predetermined first reference value and exceeds a predetermined second reference value which is greater than the first reference value.

11. The information display device of claim 1, wherein the processor is configured to obtain the collision warning information or the inter-vehicle distance control information in connection with an in-vehicle forward collision warning (FCW) system or a smart cruise control (SCC) system.

12. The information display device of claim 1, wherein the processor is configured to display the inter-vehicle distance information depending on an inter-vehicle distance setting step in the augmented reality when setting an inter-vehicle distance.

13. The information display device of claim 12, wherein the processor is configured to display an inter-vehicle distance setting value or an inter-vehicle distance setting range that varies depending on a vehicle speed or a road grade.

14. The information display device of claim 1, wherein the collision warning information includes an indicator and a marker, and the processor is configured to track the target vehicle, to display the marker around the target vehicle, and to display the indicator at a fixed position on a screen displaying the collision warning information.

15. An information display device including:
a processor configured to display departure information related to a target vehicle in augmented reality; and
a storage configured to store data and algorithms driven by the processor,
wherein the processor, based on information received from a vehicle control device, is configured to display the departure information related to the target vehicle according to at least one of a traveling direction, a path, and a lane trajectory of the target vehicle, and
wherein the information display apparatus is disposed within a vehicle or outside the vehicle, and when disposed outside the vehicle, is configured to transmit the departure information related to the target vehicle to the vehicle or a mobile device.

16. The information display device of claim 15, wherein the processor is configured to display a predetermined display object indicating the traveling direction of the target vehicle in a carpet to move the predetermined display object from the vehicle to the target vehicle when displaying the departure information related to the target vehicle.

17. The information display device of claim 16, wherein the predetermined display object includes a fishbone shape or a straight line (-) shape.

18. The information display device of claim 16, wherein the processor is configured to fix the predetermined display object, which is moved when the vehicle departs after the target vehicle departs, in the carpet to continuously display the predetermined display object.

19. The information display device of claim 15,
wherein the processor is configured to determine position information related to the target vehicle and a distance between the target vehicle and the vehicle, and
wherein the processor is configured to estimate a curve of a traveling direction of the target vehicle within a range of a maximum distance that the target vehicle can move.
